(19) United States
(12) Patent Application Publication
(10) Pub. No.: US 2008/0141971 A1
(43) Pub. Date: Jun. 19, 2008

(54) CYLINDER HEAD AND EXHAUST SYSTEM OF A MULTI-CYLINDER ENGINE

(76) Inventors: Chan Hyo Park, Hwaseong-city (KR); Si Hun Lee, Anyang-city (KR); Wootae Kim, Suwon-city (KR); Ingee Suh, Yongin-city (KR); Jong Bae Kim, Ulsan (KR); Jae Kee Lee, Ulsan (KR)

Correspondence Address: MORGAN, LEWIS & BOCKIUS LLP (SF), One Market, Spear Street Tower, Suite 2800, San Francisco, CA, 94105, US

(21) Appl. No.: 11/950,997

(22) Filed: Dec. 5, 2007

(30) Foreign Application Priority Data
Dec. 13, 2006 (KR) 10-2006-0127396
Dec. 14, 2006 (KR) 10-2006-0128177
Jan. 18, 2007 (KR) 10-2007-0005730

(51) Int. Cl. F02F 1/42

(52) U.S. Cl. 123/193.5

(57) ABSTRACT

Exhaust passages are integrally formed in at least a projection portion protruded from a side portion of a cylinder head. Interference between a vehicle body and an exhaust manifold can be reduced in a limited engine compartment space and engine performance can thereby be improved,

### CROSS-REFERENCE TO RELATED) APPLICATION

This application claims priority to and the benefit of Korean Patent Applications No. 10-2006-0128177, filed in the Korean Intellectual Property Office on Dec. 14, 2006, No. 10-2006-0127396 filed on Dec. 13, 2006, and No. 10-2007-0005730 filed on Jan. 18, 2007, the entire contents of which are incorporated herein by reference.

### BACKGROUND OF THE INVENTION

(a) Field of the Invention

The present invention relates to a cylinder head and exhaust system of a multi-cylinder engine.

(b) Description of the Related Art

Typically, an engine for a vehicle is an internal combustion engine and has a system called an exhaust system for exhausting exhaust gas combusted in a cylinder.

According to a general exhaust system, an exhaust port is formed in the cylinder head such that the exhaust gas of the cylinder is exhausted through the cylinder head. The exhaust gas exhausted from a plurality of exhaust ports of a multi-cylinder engine is collected by an exhaust manifold and supplied to a catalytic converter.

FIG. 1 is a perspective view showing a conventional exhaust system and FIG. 2 shows a side view of a conventional exhaust system.

Typically, an exhaust manifold 100 is mounted to one side of a cylinder head 101 through a flange 103, and the exhaust gas exhausted from respective combustion chambers of the engine is collected in exhaust pipes 107 integrally formed to each runner 105 connected to each port and is supplied to a catalytic converter 109.

The exhaust manifold 100 is generally manufactured as a separate member from the engine and is connected to the engine by a bolt. The conventional exhaust manifold connecting the plurality of exhaust ports with one catalytic converter occupies much volume. In addition, in a case in which passages of the exhaust manifold are joined together step by step, e.g., four passages are joined as two passages and the two passages are joined as one passage, for improving engine performance, a problem occurs in which the exhaust manifold is difficult to connect to the engine by the bolt because an outer scheme of the exhaust manifold is complicated.

That is, referring to FIG. 2, according to the exhaust system of the prior art, first and third runners 105 are respectively joined to one exhaust passage 107 and the second and fourth runners 105 respectively joined to the other exhaust passage 107. Then, the respective exhaust passages 107 are connected to the catalytic converter 109. However, by the above-described joining method, the scheme of the exhaust manifold 100 is complicated, and as shown in FIG. 2, a problem occurs that bolt engagement to mounting holes 111 of the flange 103 becomes difficult because of interference between the respective runners 105 and the exhaust pipe 107.

In addition, the temperature of exhaust gas exhausted from the cylinder is very high. Therefore, a water jacket is formed in the cylinder head such that the cylinder head through which the exhaust gas firstly flows does not overheat.

However, since the exhaust manifold in the conventional art is exposed to the outside and is manufactured as a separate member from the engine, the exhaust manifold is not cooled by the water jacket but is cooled only by a flow of air.

In contrast, if the exhaust system is compactly formed, an engine compartment space may be efficiently utilized. In addition, if an exhaust system that can decrease the temperature of the exhaust gas is provided, engine performance and durability can be improved together.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a cylinder head and exhaust system of a multi-cylinder engine having advantages of improving engine performance and spatial efficiency of an engine room.

An exemplary embodiment of the present invention provides a cylinder head for a multi-cylinder engine having a plurality of cylinders, the cylinder head having a plurality of exhaust ports so as to form at least one exhaust port for each cylinder, the cylinder head including at least one projection portion that is projected from a side wall of the cylinder head such that a plurality of exhaust passages connected to the plurality of exhaust ports may be formed in the at least one projection portion, and each of the plurality of exhaust passages extends from a corresponding exhaust port toward a single direction to form an outlet thereof.

The at least one projection portion may be a single projection portion having all exhaust passages of all cylinders of the multi-cylinder engine formed therein integrally.

The at least one exhaust port may be formed as a pair of exhaust ports for each cylinder, and the pair of exhaust ports are joined to form a single exhaust passage.

A water jacket may be formed in the at least one projection portion so as to enclose the plurality of exhaust passages.

The multi-cylinder engine may be a four cylinder engine having four cylinders.

The single direction may be a direction toward the front of the engine.

The multi-cylinder engine includes four or more cylinders and the at least one projection portion may include a first projection portion including exhaust passages of the first and second cylinders among four or more cylinders and a second projection portion including exhaust passages of the third and fourth cylinders among four or more cylinders.

The longitudinal axis of the first projection portion may be slanted at a first predetermined angle with respect to the longitudinal direction of the cylinder head. The longitudinal axis of the second projection portion may be slanted at a second predetermined angle with respect to the longitudinal direction of the cylinder head. The first predetermined angle and the second predetermined angle may be the same in an example.

The at least one exhaust port may be formed as a pair in the respective cylinder, and the pair of exhaust ports are joined together to form one exhaust passage.

The multi-cylinder engine may be a four cylinder engine having four cylinders.

The single direction is a direction toward the front of the engine.

An exemplary embodiment of the present invention provides an exhaust system of a multi-cylinder engine having a cylinder head, at least one exhaust pipe, and a catalytic converter, wherein the cylinder head has a plurality of exhaust ports so as to form at least one exhaust port for each cylinder, and includes at least one projection portion that is projected from a side wall of the cylinder head such that a plurality of exhaust passages connected to the plurality of exhaust ports may be formed in the at least one projection portion and each of the plurality of exhaust passages extends from a corresponding exhaust port toward a single direction to form an outlet thereof, and the outlets of the plurality of exhaust passages are connected to the catalytic converter through the at least one exhaust pipe.

The at least one projection portion may be a single projection portion having all exhaust passages of all cylinders of the multi-cylinder engine formed therein integrally.

The outlets of the entire exhaust passages of the single projection portion may be connected to the catalytic converter through one exhaust pipe.

A water jacket may be formed in the at least one projection portion so as to enclose the plurality of exhaust passages.

The at least one exhaust port may be formed as a pair for each cylinder, and the pair of exhaust ports are joined to form a single exhaust passage.

The multi-cylinder engine may be a four cylinder engine having four cylinders.

The single direction may be a direction toward the front of the engine.

The multi-cylinder engine includes four or more cylinders, and the at least one projection portion may include a first projection portion including exhaust passages of the first and second cylinders among four or more cylinders and a second projection portion including exhaust passages of the third and fourth cylinders among four or more cylinders.

The longitudinal axis of the first projection portion and the second projection portion are slanted with a first predetermined angle and a second predetermined angle respectively with respect to the longitudinal direction of the cylinder head. In an example the first predetermined angle and the second predetermined angle are the same.

Outlets of exhaust passages of the first projection portion may be connected to the catalytic converter through the first exhaust pipe, and outlets of exhaust passages of the second projection portion are connected to the catalytic converter through the second exhaust pipe.

A water jacket enclosing the plurality of exhaust passages may be formed in the projection portion.

The at least one exhaust port may be formed as a pair for each cylinder and the pair of exhaust ports may be joined to form a single exhaust passage integrally.

The multi-cylinder engine may be a four cylinder engine having four cylinders.

The single direction may be a direction toward the front of the engine.

In a cylinder head for a multi-cylinder engine having a plurality of cylinders, the cylinder head having a plurality of exhaust ports and a plurality of intake ports so as to form at least one exhaust port and at least one intake port for each cylinder, the cylinder head may include a first elongated portion extending from an exterior surface of the cylinder head such that an intake manifold connected to an intake port is mounted therein and the intake manifold is connected to an intake pipe mounted outside of the cylinder head by the first elongated portion.

A portion of a water jacket guiding coolant and located around the intake manifold may be mounted to the first elongated portion to enclose the intake manifold.

A cylinder head of an engine having a plurality of cylinders connected to at least one intake port and at least one exhaust port may include a first elongated portion extending from one exterior surface of the cylinder head such that an end of an intake manifold connected to the at least one intake port is mounted therein and another end of the intake manifold is connected to the intake pipe outside the cylinder head through the first elongated portion and a second elongated portion extending from another exterior surface of the cylinder head such that an end of an exhaust manifold is connected to an exhaust port is mounted therein, and another end of the exhaust manifold is connected to the exhaust pipe outside the cylinder head through the second elongated portion.

A portion of a water jacket guiding coolant and located around of the intake manifold and exhaust manifold may be mounted to the first elongated portion and the second elongated portion to enclose the first elongated portion and the second elongated portion.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view showing a conventional exhaust system.

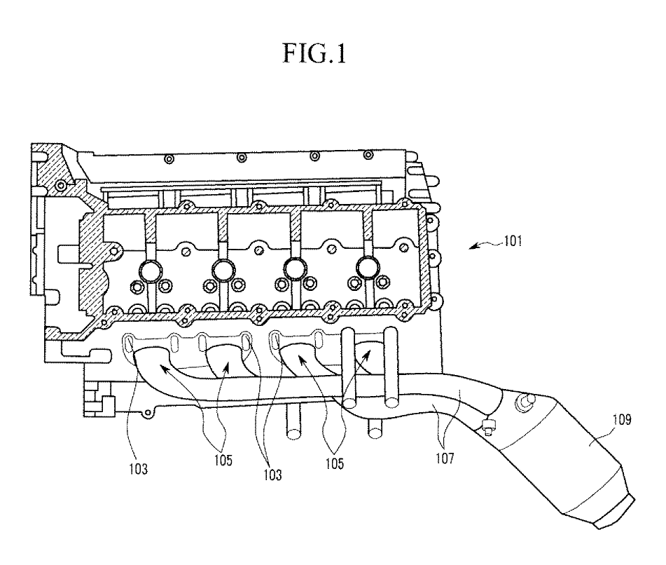

FIG. 2 shows a side view of a conventional exhaust system.

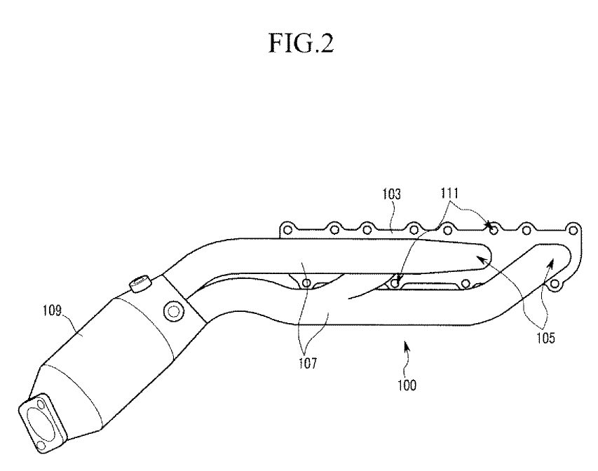

FIG. 3 shows a cylinder head and an exhaust system according to the first exemplary embodiment of the present invention.

FIG. 4 shows a water jacket formed in a cylinder head according to the first exemplary embodiment of the present invention.

FIG. 5 shows a cylinder head and exhaust system according to the second exemplary embodiment of the present invention.

FIG. 6 shows a water jacket formed in a cylinder head according to the second exemplary embodiment of the present invention.

FIG. 7 is a simple schematic diagram of a cylinder head according to the third exemplary embodiment of the present invention.

FIG. 8(a) shows a connecting portion of an intake pipe according to a D-D direction in FIG. 7 and FIG. 8(b) shows a connecting portion of an exhaust pipe according to an A-A direction.

FIG. 9(a) and FIG. 9(b) show a shape of an intake manifold of a cylinder head in FIG. 8.

FIG. 10(a) and FIG. 10(b) show a shape of an exhaust manifold of a cylinder head in FIG. 7.

FIG. 11 is a sectional view showing a cylinder head according to a B-B line in FIG. 7 and showing an arrangement of a water jacket.

FIG. 12(a) is a sectional view of a cylinder head according to an E-E line in FIG. 7 showing an arrangement of a water jacket around of an intake manifold and FIG. 12(b) is a sectional view of a cylinder head according to a C-C line in FIG. 7 showing an arrangement of a water jacket around of an exhaust manifold.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

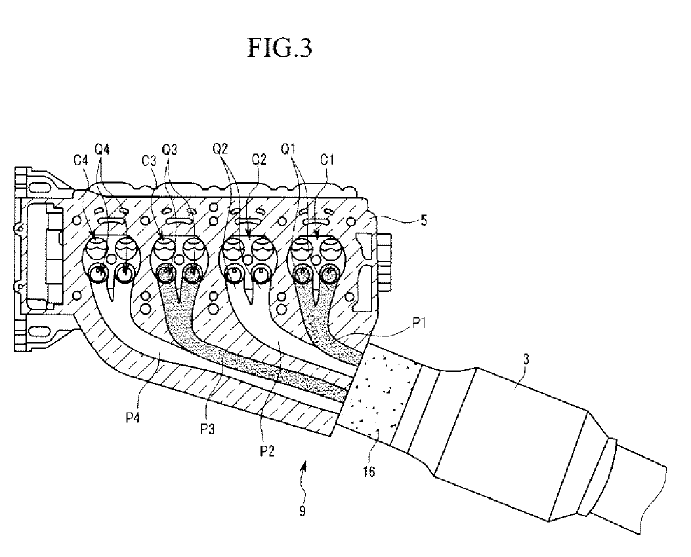

FIG. 3 shows a cylinder head and an exhaust system according to the first exemplary embodiment of the present invention.

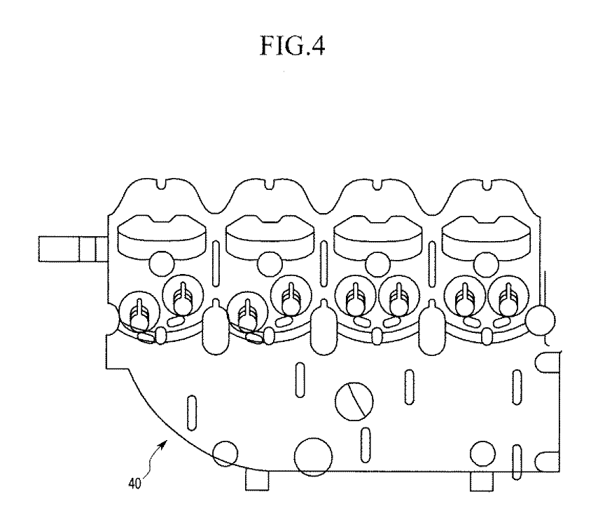

FIG. 4 shows a water jacket formed in a cylinder head according to the first exemplary embodiment of the present invention.

As shown in FIG. 3, according to the first exemplary embodiment of the present invention, the exhaust system includes a cylinder head 5, an exhaust pipe 16, and a catalytic converter 3.

In the first exemplary embodiment of the present invention, the cylinder head 5 is for a multi-cylinder engine having a plurality of cylinders C1, C2, C3, and C4 having at least one exhaust port Q1, Q2, Q3, and Q4 for each cylinder.

In this embodiment, the At least one projection portion 9 protruded from one side portion from the cylinder head 5 is formed such that a plurality of exhaust passages P1, P2, P3, and P4 connected to the exhaust ports Q1, Q2, Q3, and Q4 are formed therein integrally.

A water jacket may be formed in the at least one projection so as to enclose the plurality of exhaust passages. In detail, in an exemplary embodiment of the present invention, referring to FIG. 3 and FIG. 4, a water jacket 40 is formed in the at least one projection portion 9 so as to enclose the plurality of exhaust passages P1, P2, P3, and P4. Therefore, overheating of the cylinder head 5 can be prevented by the above described water jacket 40 and thus durability and the spatial efficiency of engine is improved.

Referring to FIG. 3, the plurality of exhaust passages P1, P2, P3, and P4 are configured to extend from respective exhaust port Q1, Q2, Q3, and Q4 toward a single direction to form an outlet thereof. According to an exemplary embodiment of the present invention, the single direction is a direction toward the front of the engine. That is, the exhaust passages P1, P2, P3, and P4 are connected to the exhaust ports Q1, Q2, Q3, and Q4 and extends from the cylinders C1, C2, C3, and C4 along a side face of the cylinder head 5 and are bent in the front direction of the engine with a predetermined angle with respect to the longitudinal direction of the cylinder head.

According to an exemplary embodiment of the present invention, the engine is realized as a four-cylinder engine, but the scope of the present invention is not limited thereto. As an example, the technical solution of the present invention can be easily realized for an engine such as an in-line 6 cylinder engine.

In addition, according to an exemplary embodiment of the present invention, it is described that the exhaust ports Q1, Q2, Q3, and Q4 of each cylinder are formed as pairs, but the scope of the present invention is not limited thereto. The technical solution of the present invention can be easily realized for the engine in which one cylinder is connected to one exhaust port.

As shown in FIG. 3, according to an exemplary embodiment of the present invention, the pairs of exhaust ports Q1, Q2, Q3, and Q4 are respectively connected to one exhaust passage P1, P2, P3, and P4. However, the scope of the present invention is not limited thereto. In a case in which the pairs of exhaust ports Q1, Q2, Q3, and Q4 are not connected and are extended to the outlet, the technical solution of the present invention can still be easily realized.

As shown in FIG. 3, according to an exemplary embodiment of the present invention, the at least one projection portion is a single projection portion 9 has integrally all exhaust passages P1, P2, P3, and P4 extending respectively from cylinders C1, C2, C3, and C4 of the multi-cylinder engine formed therein.

According to the exhaust system of the first exemplary embodiment of the present invention, the outlets of the plurality of exhaust passages P1, P2, P3, and P4 of the engine are connected to the catalytic converter 3 through at least one exhaust pipe 16.

According to the first exemplary embodiment of the present invention, the Outlets of all exhaust passages P1, P2, P3, and P4 integrally formed in the one projection portion 9 in common are connected to the catalytic converter 3 by the one exhaust pipe 16 as shown in FIG. 3.

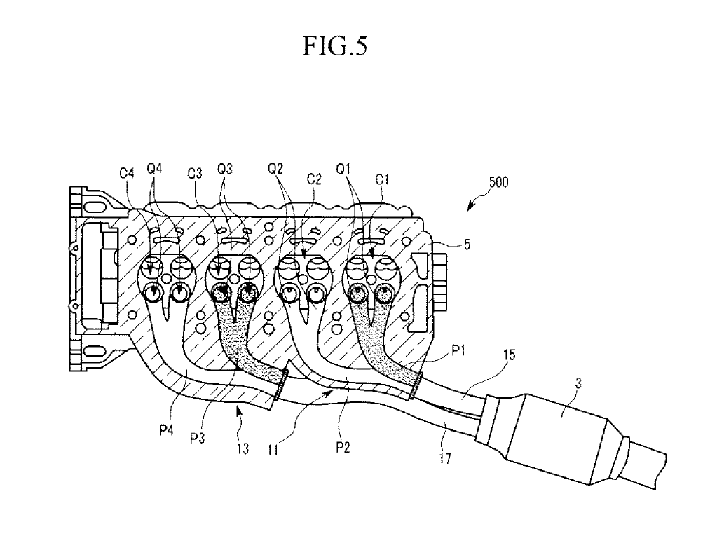

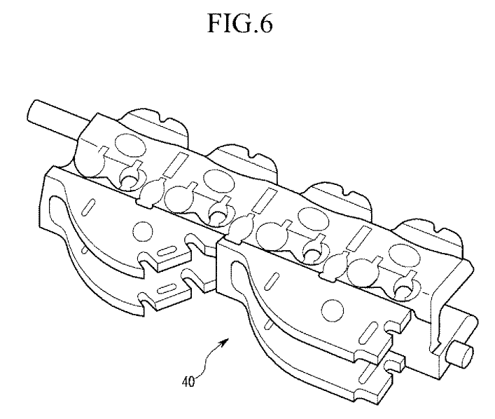

Hereinafter, referring to FIG. 5 and FIG. 6, an exhaust system 500 according to the second exemplary embodiment of the present invention is described.

According to the second exemplary embodiment of the present invention, the exhaust system 500 includes an identical scheme to the first exemplary embodiment, but the exhaust system 500 is formed as two projection portions 11 and 13 in this example as shown in FIG. 5.

That is, according to the second exemplary embodiment of the present invention, the first projection portion 11 defines exhaust passages P1 and P2 of first and second cylinders C1 and C2 of the four cylinders and a second projection portion 13 defines exhaust passages P3 and P4 of third and fourth cylinders C3 and C4 thereof.

The longitudinal axis of first projection portion 11 may be slanted in a first predetermined angle with respect to the longitudinal direction of the cylinder head 5. The longitudinal axis of the second projection portion 13 may be slanted in a second predetermined angle with respect to the longitudinal direction of the cylinder head 5.

The first or second predetermined angles may be selected by a person of ordinary skill in the art based on the teachings herein. In an exemplary embodiment, the first predetermined angle and the second predetermined angle may be the same. By the above-described scheme, the space of an engine compartment can be more effectively utilized.

In addition, according to the second exemplary embodiment of the present invention, the respective exhaust system outlets of the plurality of exhaust passages P1, P2, P3, and P4 of the engine are connected to the catalytic converter 3 through the at least two exhaust pipes 15 and 17 in this example.

According to the second exemplary embodiment of the present invention, the outlets of the exhaust passages P1 and P2 of the first projection portion 11 are connected to the catalytic converter 3 through the first exhaust pipe 15 and the outlets of the exhaust passages P3 and P4 of the second projection portion 13 are connected to the catalytic converter 3 through the second exhaust pipe 17.

FIG. 6 shows a water jacket formed in a cylinder head according to the second exemplary embodiment of the present invention.

According to the exhaust system of the multi-cylinder engine of an exemplary embodiment of the present invention, the exhaust passages that are formed by protruding from one side portion of the cylinder head and are utilized as an exhaust manifold are integrally formed. Therefore, interference with the vehicle body can be reduced in a limited engine compartment space and the engine compartment space can be effectively utilized.

In addition, because an entire weight including the cylinder head and the exhaust manifold can be reduced, vehicle driving performance can be improved.

Furthermore, since the exhaust passage connected to the exhaust port is integrally formed on the cylinder head and the exhaust passage is cooled by the water jacket, heat durability of the cylinder head can be improved.

Hereinafter, referring to the drawings, according to the third exemplary embodiment of the present invention, a cylinder head is described.

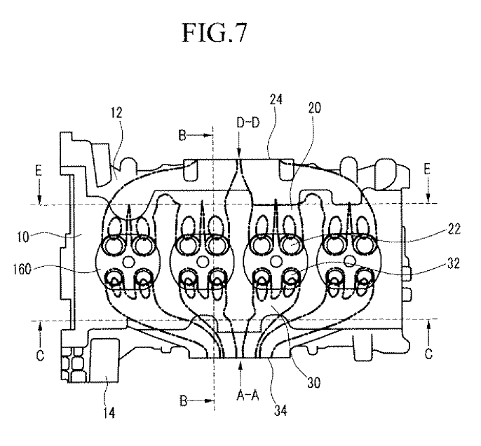

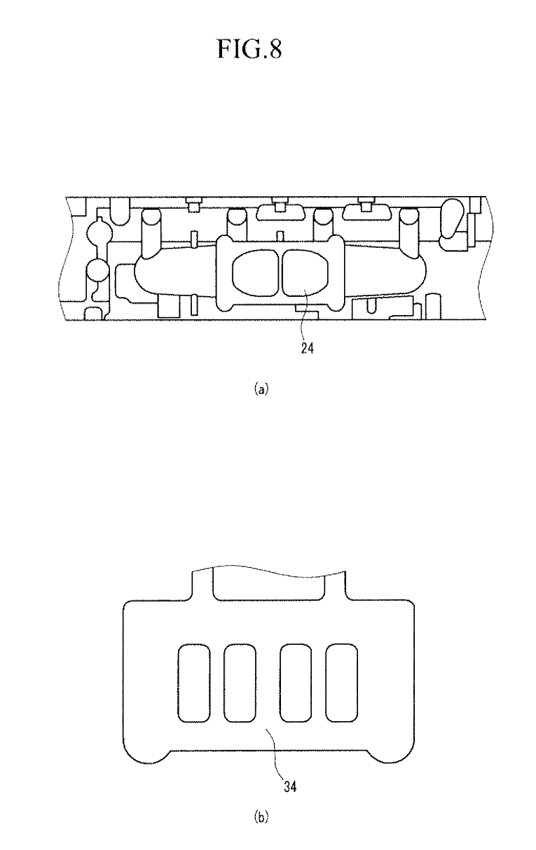

FIG. 7 is a simple schematic diagram of a cylinder head according to the third exemplary embodiment of the present invention, FIG. 8(a) shows an intake pipe connecting portion 24 seen in the D-D direction of FIG. 7, and FIG. 8(b) shows an exhaust pipe connecting portion 34 seen in the A-A direction of FIG. 7.

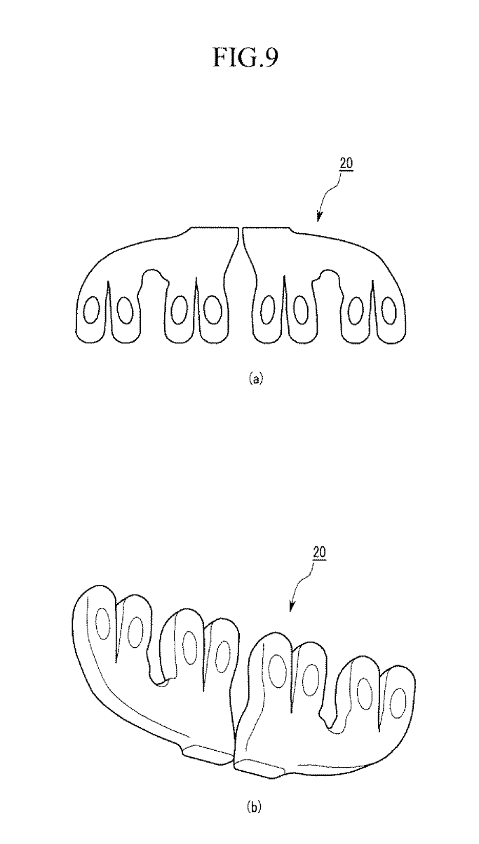

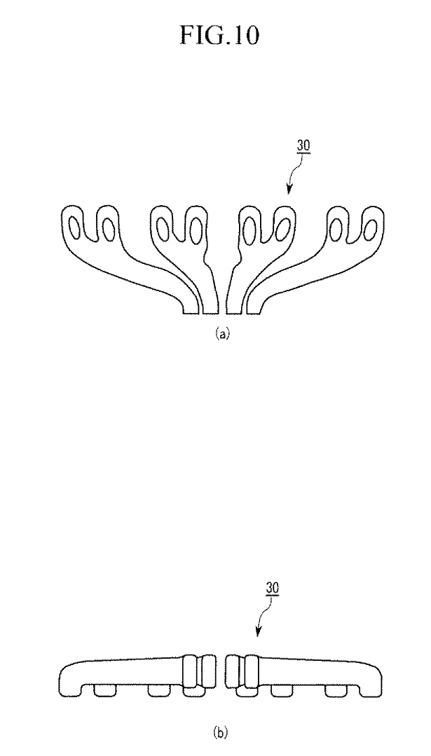

In addition, FIG. 9(a) and FIG. 9(b) show a shape of an intake manifold 20 of a cylinder head in FIG. 7 and FIG. 10(a) and FIG. 10(b) show a shape of an exhaust manifold 30 of a cylinder head in FIG. 7.

According to an exemplary embodiment of the present invention, the engine is realized as a four-cylinder engine, but the scope of the present invention is not limited thereto.

According to the third exemplary embodiment of the present invention, the cylinder head, as shown in FIG. 7, includes an intake manifold 20 and an exhaust manifold 30. Four cylinders 160 are formed in tie cylinder head 10.

The intake manifold 20 and the exhaust manifold 30 are respectively connected to an intake port 22 and an exhaust port 32 formed onto both upper sides of each cylinder 160.

Because the two intake ports 22 are formed per a cylinder 160, one end portion of the intake manifold 20 is branched as eight pipes that are respectively connected to the intake ports 22 in this embodiment. In contrast, the other end portion of the intake manifold 20 may be joined to form an intake pipe connection portion 24 as explained below.

Similarly, because the two exhaust ports 32 are formed per a cylinder 160, one end portion of the exhaust manifold 30 is branched as eight pipes that are respectively connected to the exhaust ports 32 in this embodiment. In contrast, the other end portion of the exhaust manifold 30 may also be joined to form an exhaust pipe connecting portion 34 as explained below.

In addition, according to an exemplary embodiment of the present invention, the cylinder head 10 includes a first elongated portion 12 extended from one side of the cylinder head 10 such that the intake manifold 20 connected to the plurality of intake ports 22 is formed therein.

The other end portion of the intake manifold 20 forms an intake pipe connecting portion 24 connected to the intake pipe (not shown) outside of the cylinder head 10 through the first elongated portion 12.

On the other hand, the cylinder head according to the third exemplary embodiment of the present invention includes a second elongated portion 14 extended from another exterior surface of the cylinder head 10 such that the exhaust manifold 30 connected to the exhaust ports is mounted therein

Next, the other end portion of the exhaust manifold 30 forms an exhaust pipe connecting portion 34 connected to the exhaust pipe (not shown) outside of the cylinder head 10 through the second elongated portion 14.

According to the third exemplary embodiment of the present invention, the intake manifold 20 and the exhaust manifold 30 are not separately attached to the outside of the cylinder head 10 but integrally formed in the cylinder head 10.

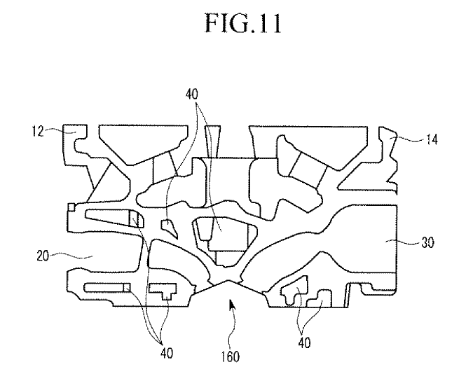

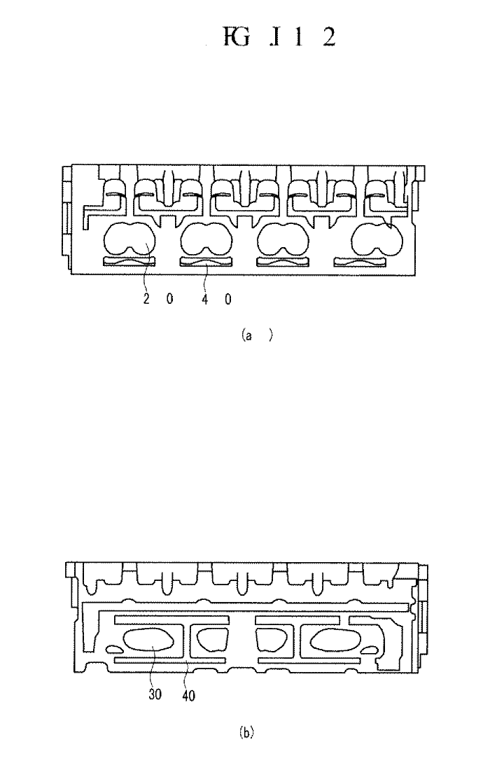

That is, the intake manifold 20 and the exhaust manifold 30, as shown in FIG. 11 and FIG. 12, are integrally formed in the cylinder head 10.

However, as shown in FIG. 9 and FIG. 10, the shape of the intake manifold 20 and the exhaust manifold 30 are an example so as to explain the present invention, and the present invention is not limited thereto.

As described, the intake manifold 20 and the exhaust manifold 30 according to the third exemplary embodiment of the present invention are formed to be disposed in the cylinder head 10, and for the disposition, according to the third exemplary embodiment of the present invention, the cylinder head 10 includes the first elongated portion 12 and the second elongated portion 14.

The first elongated portion 12 and the second elongated portion 14 can be integrally formed/manufactured with the cylinder head 10 or they can be manufactured as a flange type and respectively connected to the outside of the cylinder head 10.

As described, according to the third exemplary embodiment of the present invention, interference between the parts can be reduced and when the intake/exhaust manifolds are manufactured or assembled, manufacturing room can be reduced.

FIG. 11 is a sectional view showing a cylinder head according to B-B line in FIG. 7 and showing an arrangement of a water jacket 40, intake manifold 20 and exhaust manifold 30. FIG. 12(a) is a sectional view of a cylinder head according to an E-E line in FIG. 7 showing an arrangement of a water jacket 40 around of an intake manifold 20 and FIG. 12(b) is a sectional view of a cylinder head according to a C-C line in FIG. 7 showing an arrangement of a water jacket 40 around of an exhaust manifold 30.

Generally, a water jacket 40 guiding coolant is disposed in the cylinder head 10.

According to the third exemplary embodiment of the present invention, as shown in FIGS. 11 and 12, the water jacket 40 extends to the first elongated portion 12 and the second elongated portion 14 such that the water jacket 40 is disposed around the intake manifold 20 and the exhaust manifold 30 to enclose the intake manifold 20 and the exhaust manifold 30.

As described, according to the present invention, the problem that fuel consumption is deteriorated by increasing the engine compartment temperature by the intake/exhaust manifolds having engine heat can be solved.

Particularly, because the water jacket 40 is disposed around the exhaust manifold 30 having high heat temperature, durability of the exhaust manifold 30 can be improved since the exhaust manifold is cooled by the water jacket effectively in contrast to the conventional art that but is cooled only by a flow of air.

As described above, according to the third exemplary embodiment of the present invention, because the cylinder head includes the intake manifold and the exhaust manifold integrally formed therein, interference between the elements of the engine on the engine package can be prevented.

In addition an engine compartment space may be efficiently utilized since the entire engine system can be designed compactly.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A cylinder head for a multi-cylinder engine having a plurality of cylinders, the cylinder head having a plurality of exhaust ports so as to form at least one exhaust port for each cylinder, the cylinder head comprising:
at least one projection portion that is projected from a side wall of the cylinder head such that a plurality of exhaust passages connected to the plurality of exhaust ports may be integrally formed in the at least one projection portion,
wherein each exhaust passage extends from corresponding exhaust port along each single direction to form an outlet thereof.

2. The cylinder head of claim 1, wherein the at least one projection portion is a single projection portion having all exhaust passages of all cylinders formed therein integrally.

3. The cylinder head of claim 2, wherein the exhaust ports are formed as a pair per a cylinder, and the pair of exhaust ports are joined to form a single exhaust passage.

4. The cylinder head of claim 2, wherein a water jacket is formed in the at least one projection portion so as to enclose the exhaust passages therein.

5. The cylinder head of claim 2, wherein the engine is a four cylinder engine including four cylinders.

6. The cylinder head of claim 2, wherein the single direction is a direction toward the front of the engine.

7. The cylinder head of claim 1, wherein the multi-cylinder engine includes four or more cylinders, and the at least one projection portion comprises:
a first projection portion including exhaust passages of the first and second cylinders among the cylinders; and
a second projection portion including exhaust passages of the third and fourth cylinders among the cylinders.

8. The cylinder head of claim 7, wherein a longitudinal axis of the first projection portion is slanted at a first predetermined angle with respect to the longitudinal direction of the cylinder head and wherein a longitudinal axis of the second projection portion is slanted at a second angle with respect to the longitudinal direction of the cylinder head.

9. The cylinder head of claim 8, wherein the first predetermined angle and the second predetermined angle is the same.

10. The cylinder head of claim 7, wherein the at least one exhaust port is formed as a pair in the respective cylinders and the pair of exhaust ports are joined together to form one exhaust passage.

11. The cylinder head of claim 7, wherein the multi-cylinder engine is a four cylinder engine including four cylinders.

12. An exhaust system of a multi-cylinder engine having a cylinder head, at least one exhaust pipe, and a catalytic converter, wherein the cylinder head has a plurality of exhaust ports so as to form at least one exhaust port for each cylinder, the cylinder head comprises:
at least one projection portion that is projected from a side wall of the cylinder head such that a plurality of exhaust passages connected to the plurality of exhaust ports may be integrally formed in the at least one projection portion,
wherein each exhaust passage extends from corresponding exhaust ports along each single direction to form an outlet thereof; and
wherein the outlets of the plurality of exhaust passages are connected to the catalytic convener through the at least one exhaust pipe.

13. An exhaust system of claim 12, wherein the at least one projection portion is a single projection portion having all exhaust passages of all cylinders formed integrally therein.

14. An exhaust system of claim 13, wherein the outlets of all exhaust passages of the single projection portion are connected to the catalytic converter through at least one exhaust pipe.

15. An exhaust system of claim 14, wherein a water jacket is formed in the at least one projection portion so as to enclose the exhaust passages therein.

16. An exhaust system of claim 13, wherein the at least one exhaust port is formed as a pair per a cylinder, and the pair of exhaust ports are joined to form a single exhaust passage.

17. An exhaust system of claim 13, wherein the multi-cylinder engine is a four cylinder engine including four cylinders.

18. An exhaust system of claim 13, wherein the single direction is a direction toward the front of the engine.

19. The exhaust system of a multi-cylinder engine of claim 12, wherein the multi-cylinder engine includes four or more cylinders, and the at least one projection portion comprises:
a first projection portion including exhaust passages of the first and second cylinders among the cylinders; and
a second projection portion including exhaust passages of the third and fourth cylinders among the cylinders.

20. The exhaust system of a multi-cylinder engine of claim 19,
wherein a longitudinal axis of the first projection portion is slanted at a first predetermined angle with respect to the longitudinal direction of the cylinder head, and
wherein a longitudinal axis of the second projection portion is slanted at a second angle with respect to the longitudinal direction of the cylinder head.

21. The exhaust system of a multi-cylinder engine of claim 20, wherein the first predetermined angle and the second predetermined angle is the same.

22. The exhaust system of a multi-cylinder engine of claim 19, wherein outlets of exhaust passages of the first projection portion are connected to the catalytic converter through a first exhaust pipe, and outlets of exhaust passages of the second projection portion are connected to the catalytic converter through a second exhaust pipe.

23. The exhaust system of a multi-cylinder engine of claim 19, wherein a water jacket enclosing the plurality of exhaust passages is formed in the projection portion.

24. The exhaust system of a multi-cylinder engine of claim 19, wherein the at least one exhaust port is formed as a pair for each cylinder, and the pair of exhaust ports are joined to form a single exhaust passage.

25. The exhaust system of a multi-cylinder engine of claim 19, wherein the multi-cylinder engine is a four cylinder engine including four cylinders.

26. The exhaust system of a multi-cylinder engine of claim 19, wherein the single direction is a direction toward the front of the engine.

27. A cylinder head for a multi-cylinder engine having a plurality of cylinders, the cylinder head having a plurality of exhaust ports and a plurality of intake ports so as to form at least one exhaust port and at least one intake port for each cylinder, the cylinder head comprising:
a first elongated portion extending from an exterior surface of the cylinder head such that an intake manifold is mounted therein,
wherein an end of the intake manifold is connected to the plurality of intake ports and the other end of the intake manifold is connected to an intake pipe mounted outside the cylinder head by the first elongated portion.

28. The cylinder head of claim 27, wherein a portion of a water jacket that guides coolant and is located around the intake manifold is mounted to the first elongated portion to enclose the intake manifold therein.

29. A cylinder head of an engine having a plurality of cylinders connected to at least one intake port and at least one exhaust port, comprising:
a first elongated portion extending from one exterior surface of the cylinder head such that an intake manifold is mounted therein, wherein an end of the intake manifold is connected to the at least an intake port and another end of the intake manifold is connected to an intake pipe positioned outside the cylinder head through the first elongated portion, and
a second elongated portion extending from another exterior surface of the cylinder head such that an exhaust manifold is mounted therein, wherein an end of the exhaust manifold is connected to the at least an exhaust port and another end of the exhaust manifold is connected to an exhaust pipe positioned outside the cylinder head through the second elongated portion.

30. The cylinder head of claim 29, wherein a portion of a water jacket which guides coolant and is located around the intake manifold and the exhaust manifold is mounted to the first elongated portion and the second elongated portion to enclose the intake manifold and the exhaust manifold therein.
